(19) United States
(12) Patent Application Publication
(10) Pub. No.: US 2004/0233915 A1
(43) Pub. Date: Nov. 25, 2004

(54) Speech transmitting method for saving the bandwidth

(76) Inventor: Haitao Lin, Guangdong (CN)

Correspondence Address: HARNESS, DICKEY & PIERCE, P.L.C., P.O. BOX 828, BLOOMFIELD HILLS, MI, 48303, US

(21) Appl. No.: 10/484,977

(22) PCT Filed: Jun. 7, 2002
(86) PCT No.: PCT/CN02/00410

(30) Foreign Application Priority Data
Jul. 27, 2001 (CN) 01123704X

(51) Int. Cl. H04L 12/28

(52) U.S. Cl. 370/395.52

(57) ABSTRACT

The invention relates to a voice transmission method for saving bandwidth, which can save bandwidth without voice transmission quality being degraded in private network application environment. Since network quality of private network is good and probability of packet loss, disorder and jitter is small, and in RTP protocol used for transmitting IP voice, the RTP packet header occupies a large amount of bytes, which wastes precious bandwidth resources, the RTP packet header for IP private network is simplified according to the invention. The rule of the simplification is to delete unnecessary parts of the structure of the RTP packet header. For example, the simplified RTP packet header includes only flag bit for mute and bits for voice encoding and decoding type of PT packet and only uses a byte. With the simplified packet header, the bandwidth usage rate of RTP packet header can be lowered from 16% to 1.6%.

### FIELD OF THE TECHNOLOGY

The invention relates to Internet Protocol (IP) telephone technology, more particularly to a method for saving bandwidth used in IP voice transmission in private network.

### BACKGROUND OF THE INVENTION

At present, the IP voice is mainly used in two environments, one is the Internet and the other is private network. The advantage of Internet is that the communication worldwide can be realized through it, and the disadvantage is that transmission quality of the network is not good. For private network, the transmission quality of the network can be guaranteed, so probability of loss, disorder and jitter for the packets after transmission is small; but communication with outside cannot be realized because it is limited inside the private network provided by the service provider.

Almost all the IP voice transmissions use the Real-time Transport Protocol (RTP) which is the standard of real-time voice transmission in IP network.

In the RTP protocol, the RTP packet header uses a great lot of bytes, as shown in FIG. 1 illustrating the structure of the RTP packet header.

As shown in FIG. 1, the numbers 00 to 09, 10 to 19, 20 to 29 and 30 to 31 in the first and second lines represent four bytes, i.e., 32 bits. Each pair of symbols ± in the third and fourth lines represents one bit. In the third and fourth lines, V represents the version number with 2 bits, P represents whether there are complementary bytes which are usually noun with 1 bit, X represents whether there is expansion with 1 bit, CC represents expansion numbers with 4 bits, M is a flag bit for mute which uses 1 bit, PT represents voice coding and decoding type of PT packets with 7 bits and the remain is sequence number of voice packets which uses 16 bits. Each pair of symbols ± in the fifth and sixth lines represents one bit. The timestamp corresponding the two lines uses 32 bits. Each pair of symbols ± in the seventh and eighth lines represents one bit also. The corresponding synchronization source identifier uses 32 bits. Also, each pair of symbols += in the ninth and tenth lines represents one bit also. The corresponding contributing source identifier can be multiple and each uses 32 bits. The eleventh and twelfth lines represent expansion if expansion exists.

It can be seen from the above analysis for RTP packet header of the RTP protocol that the RTP packet header occupies a large amount of bandwidth. Suppose an audio payload uses 20 bytes, a UDP packet header uses 8 bytes, an IP packet header uses 20 bytes, an Ethernet frame header uses 14 bytes (all of these bytes are necessary), and a RTP packet header occupies at least 12 bytes when transmitted in IP network, the ratio of the RTP packet header to the total bandwidth is:

12/(12+20+8+20+14)=16%

This means the RTP packet header uses 16% of total bandwidth. Therefore, precious bandwidth resources are really wasted in prior art.

The timestamp and sequence number fields are used to record information about loss, delay and jitter of packets during network transmission in order that appropriate processing can be implemented. Since network quality of an IP private network is good, in general, the packet loss and disorder seldom happen and the time delay is stable, the timestamp and sequence number fields are not necessary. The synchronization source identifier and the contributing source identifier are mainly used for videoconference and audio conference and thus can be ignored because the IP telephone is a point-to-point communication only.

### SUMMARY OF THE INVENTION

An object of the invention is to provide a voice transmission method for saving bandwidth which can overcome the problem that the RTP packet header in prior RTP protocol occupies a large amount of bytes and the precious bandwidth resources are wasted. The RTP protocol according to the invention is a simplified RTP protocol. It can save bandwidth without the voice transmission quality being degraded under the application condition of transmitting IP voice in private network. In private network which is a kind of special networks, the method can reduce the occupation for bandwidth by RTP packet header and realize higher network usage.

The voice transmission method for saving bandwidth according to the invention is provided through the adjustment of RTP packet header. Through deleting unnecessary contents in private network for saving bandwidth, the invention provides a means to save bandwidth used in transmitting IP voice in private network.

The voice transmission method for saving bandwidth according to the invention comprises the steps of sending, transmitting and receiving voice information, wherein the step of sending voice information further comprises a step of simplifying the structure of RTP packet header in total bandwidth and the rule of simplification is to delete parts of the structure which are unnecessary for transmitting IP voice in a private network.

The simplified RTP packet header only includes a flag bit for mute and bits for voice encoding and decoding type of PT packets.

The simplified RTP packet header occupies at most one byte of bandwidth.

Suppose an audio payload uses 20 bytes, a UDP packet header uses 8 bytes, an IP packet header uses 20 bytes, an Ethernet frame header uses 14 bytes (all of these bytes are necessary), and a simplified RTP packet header occupies at most 1 byte when transmitted in IP network according to the invention, the ratio of the simplified RTP packet header to the total bandwidth is:

1/(20+8+20+14+1)=1.6%

This means the simplified RTP packet header according to the invention only occupies 1.6% of total bandwidth. Therefore, the bandwidth is greatly saved without affecting the voice transmission quality.

### BRIEF DESCRIPTION OF THE DRAWINGS

FIG. 1 is a schematic diagram illustrating the structure of the RTP packet header in RTP protocol.

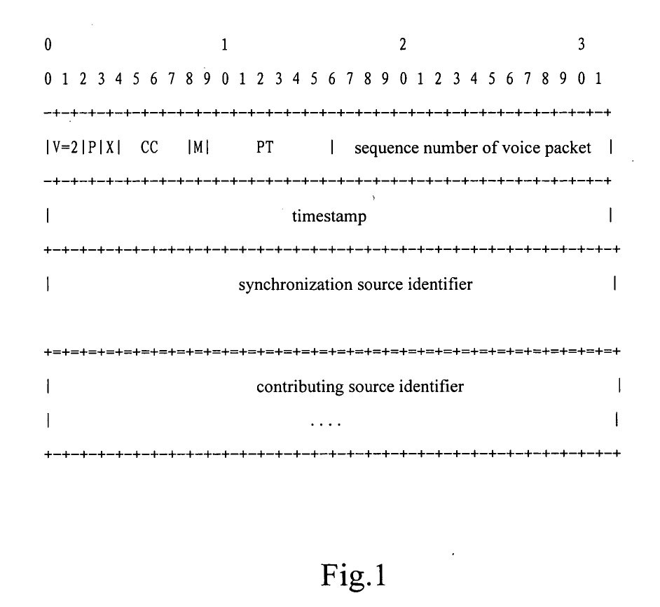

FIG. 2 is as schematic diagram illustrating the simplified structure of the RTP packet header in RTP protocol according to the invention.

### DETAILED DESCRIPTION OF THE INVENTION

The invention will be described in more detail hereinafter with reference to the accompanying drawings.

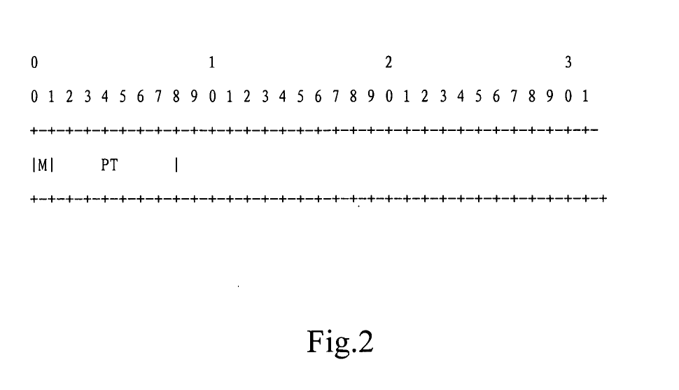

As shown in FIG. 2, unnecessary parts of the structure of RTP packet header in RTP protocol are deleted according to the rule provided in the invention under the condition of private network application. In detail, the bits used for V, P, X, CC, sequence number, timestamp, synchronization source identifier and the contributing source identifier in prior structure of RTP packet header are deleted, and only necessary contents in RTP packet header for transmitting IP voice in private network are remained. The simplified RTP packet header only occupies a byte, i.e., 8 bits (00-07). In the 8 bits, 1 bit is used for flag bit of mute, the other 7 bits are used for voice encoding and decoding type of PT packets (G.729, G.723 and G.711).

The method according to the invention can be used in IP telephone system, such as that in enterprise network. In this way, the bandwidth occupation rate of RTP packet header is lowered from 16% to 1.6% and the availability of bandwidth is raised effectively. Therefore, with the invention, the usage of bandwidth is raised without the degrading voice transmission quality.

1. A voice transmission method for saving bandwidth, comprising the steps of sending, transmitting and receiving voice information, wherein the step of sending voice information further comprises a step of simplifying the structure of RTP packet header in total bandwidth and the rule of simplification is to delete parts of the structure which are unnecessary for transmitting IP voice in a private network.

2. The method of claim 1, wherein the simplified RTP packet header only includes a flag bit for mute and bits for voice encoding and decoding type of PT packets.

3. The method of claim 2, wherein the simplified RTP packet header occupies at most one byte of bandwidth.

4. The method of claim 1, wherein the simplified RTP packet header occupies at most one byte of bandwidth.
